(19) United States
(12) Patent Application Publication
(10) Pub. No.: US 2007/0147709 A1
(43) Pub. Date: Jun. 28, 2007

(54) Adaptive resolution conversion apparatus for input image signal and and a method thereof

(75) Inventors: Young-ho Lee, Yongin-si (KR); Kihyun Hong, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/487,576

(22) Filed: Jul. 17, 2006

(30) Foreign Application Priority Data
Dec. 26, 2005 (KR) 2005-0129604

(51) Int. Cl. G06K 9/32

(52) U.S. Cl. 382/299

(57) ABSTRACT

A resolution conversion apparatus and method. The apparatus includes an image analysis unit analyzing frequency characteristics of an input image signal, a filter coefficient determination unit setting a filter coefficient according to the frequency characteristics, and a noise shaper unit performing noise shaping with respect to an error generated by quantizing the input image signal, according to the filter coefficient. Accordingly, an image can be naturally realized by performing noise shaping according to characteristics of the input image signal.

### CROSS-REFERENCE TO RELATED APPLICATIONS

This application claims benefit under 35 U.S.C. § 119(a) of Korean Patent Application No. 2005-129604, filed Dec. 26, 2005, the entire contents of which are incorporated herein by reference.

### BACKGROUND OF THE INVENTION

1. Field of the Invention

The present invention relates to a resolution conversion apparatus adaptive to an input image signal, and a method for the same. More particularly, the present invention relates to a resolution conversion apparatus adaptive to an input image signal, which decreases resolution according to characteristics of the input image signal in order to display a high-resolution image signal on a display device of low-resolution, and a method for the same.

2. Description of the Related Art

Recently, as display devices are being diversified in kind and size, an input image signal is displayed on a display device by converting its resolution. Here, in order to display a low-resolution input image signal on a display device of high resolution, resolution enhancement should be performed with respect to the input image signal. Conversely, when displaying a high-resolution input image signal on a display device of low resolution, resolution reduction of the input image signal is required.

Especially when reducing the resolution, noise such as false contours may be generated, thereby causing an awkward image on a screen. To prevent this, truncation techniques and dither techniques have been conventionally used.

FIGS. 1A through 1C illustrate a conventional method for converting resolution.

FIG. 1A is a graph illustrating an output image signal as a result of performing the truncation technique with respect to an input image signal. Conventionally, the truncation technique has been performed by quantizing the input image signal using Equation 1 as follows:
Y(i,j)=trunc(X(i,j)+0.5) (Equation 1)

In FIG. 1A and Equation 1, Y(i,j) denotes the location of a predetermined pixel included in the output image signal, and X(i,j) denotes the location of a predetermined pixel included in the input image signal.

FIG. 1B is a graph illustrating an output image signal as a result of performing random dither technique with respect to an input image signal. In FIG. 1B, Y(i,j) denotes the location of a predetermined pixel included in the output image signal, and X(i,j) denotes the location of a predetermined pixel included in the input image signal. Conventionally, the random dither technique has been performed by quantizing the input image signal using Equation 2 as follows:
Y(i,j)=trunc(X(i,j)+random noise(i,j)+0.5) (Equation 2)

In Equation 2, random noise(i,j) denotes a noise value of a pixel located at (i,j).

The dither techniques include the random dither shown in FIG. 1B, ordered dither, and error diffusion dither. The ordered dither is a technique of quantizing the input image signal according to threshold patterns using a dither matrix. The error diffusion dither is a technique of diffusing a quantizing error of the input image signal to neighboring pixels, as shown in FIG. 1C.

When performing the truncation technique with the data, false contours are generated due to the quantizing error. Although the dither technique causes less false contour than the truncation technique, the displayed image seem awkward due to the dither pattern when. This is because the truncation technique or the dither technique is performed regardless of characteristics of the input image signal.

### SUMMARY OF THE INVENTION

An aspect of the present invention addresses the above disadvantages. Accordingly, an aspect of an exemplary embodiment of the present invention provides an apparatus for adaptively converting resolution of an input image signal, the apparatus being capable of minimizing a quantizing error generated during resolution reduction by performing noise shaping according to characteristics of the input image signal.

There is also provided a resolution conversion apparatus comprising an image analysis unit analyzing frequency characteristics of an input image signal; a filter coefficient determination unit setting a filter coefficient according to the frequency characteristics; and a noise shaper unit performing noise shaping with respect to an error generated by quantizing the input image signal, according to the filter coefficient.

The noise shaper unit may include a filter unit performing noise shaping using a following equation:

$$Y = ( X - Y ) \frac{{z}^{- 1}}{1 - {z}^{- 1}} + N$$

wherein, Y denotes the output image signal, X denotes the input image signal, Z⁻¹ denotes an all pass filter, 1−Z⁻¹ denotes a high pass filter, and N denotes a quantizing error.

The image analysis unit may include a difference value calculator calculating a difference value between pixel data neighboring the input image signal; an absolute value operator calculating an absolute value of the difference value; and a comparator comparing the absolute value with a plurality of threshold values.

The resolution conversion apparatus may comprise storage storing the filter coefficient corresponding to threshold sections defined by the plurality of threshold values, in the form of a lookup table; and a selector selecting the filter coefficient from the storage, according to the result of comparison between the absolute value and the threshold values.

According to another exemplary embodiment of the present invention, there is provided a resolution conversion apparatus comprising an image analysis unit calculating a difference value between pixel data neighboring the input image signal; an order determination unit determining an order for passing the input image signal according to the difference value calculated by the image analysis unit; and a noise shaper unit performing noise shaping with respect to the error generated by quantizing the input image signal, according to the order determined by the order determination unit.

The noise shaper unit may include a plurality of switches for selecting one operation between bypassing and noise shaping of the input image signal, according to the order.

The order determination unit determines the order logarithmically corresponding to the difference value.

According to yet another exemplary embodiment of the present invention, there is provided a resolution conversion apparatus comprising an image analysis unit analyzing an edge direction from an input image signal; a dimension determination unit determining dimension for performing noise shaping with respect to an error generated by quantizing the input image signal, according to the edge direction; and a noise shaper unit performing noise shaping according to the dimension.

The noise shaper unit may include a horizontal noise shaper performing noise shaping in a horizontal direction when the edge direction is 0°; and a vertical noise shaper performing noise shaping in a vertical direction when the edge direction is 90°.

When the edge direction is 45°, the dimension determination unit may turn on switches of the horizontal and the vertical noise shaping units to perform noise shaping in an oblique direction of 2-dimension.

The noise shaper unit may further include a temporal noise shaper unit performing noise shaping in a temporal direction.

Another aspect of the present invention is to provide a method for converting resolution, comprising analyzing at least one characteristics among frequency characteristic of an input image signal, a difference value between neighboring pixel data, and an edge direction; and performing noise shaping with respect to a quantizing error according to at least one of the characteristics.

The step of performing noise shaping may include selecting a filter coefficient according to the frequency characteristic; and performing noise shaping with respect to the quantizing error by applying the filter coefficient.

The step of performing noise shaping may include determining an order of noise shaping the input image signal, according to the difference value between the neighboring pixel data; and performing one of bypassing and noise shaping of the input image signal according to the order.

The step of performing noise shaping may include determining dimension for performing noise shaping with respect to an error generated by quantizing the input image signal, according to the edge direction; and performing noise shaping according to the dimension.

### BRIEF DESCRIPTION OF THE DRAWING FIGURES

The above aspects and other features of the present invention will become more apparent by describing in detail exemplary embodiments thereof with reference to the attached drawing figures, wherein;

FIGS. 1A through 1C are views for explaining a conventional method for converting resolution;

FIGS. 2A and 2B are views modeling a noise shaper used in an exemplary embodiment of the present invention;

FIG. 3 shows a resolution conversion apparatus according to exemplary embodiments of the present invention;

FIG. 4 shows a resolution conversion apparatus according to another exemplary embodiment of the present invention;

FIGS. 5A and 5B are views for explaining a method for determining an order of the resolution conversion apparatus of FIG. 4;

FIG. 6 is a view showing a resolution conversion apparatus according to yet another exemplary embodiment of the present invention;

FIG. 7 is a view for explaining a method for determining a dimension of the resolution conversion apparatus of FIG. 6; and

FIG. 8 is a view for explaining operations of the resolution conversion apparatus according to the exemplary embodiments of the present invention.

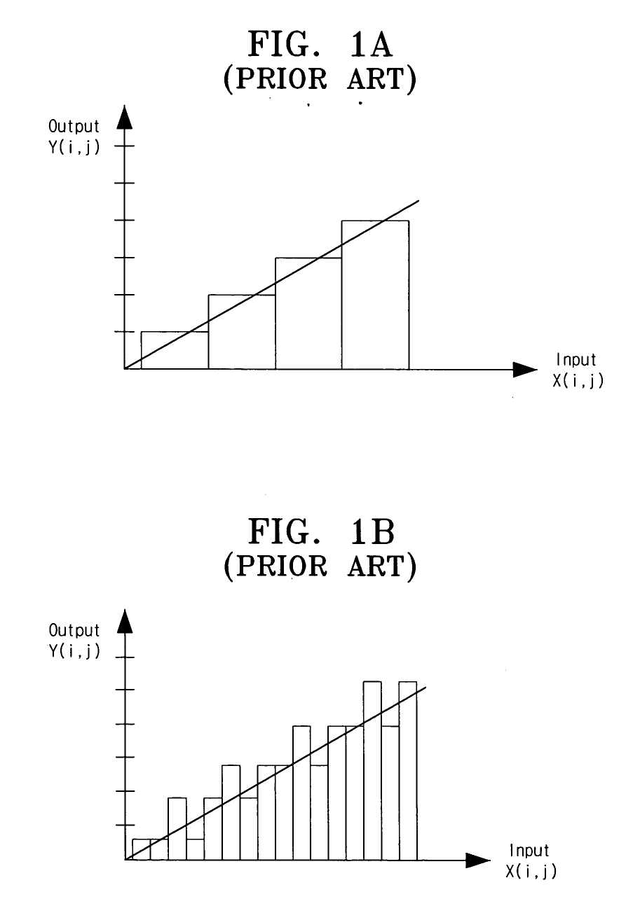

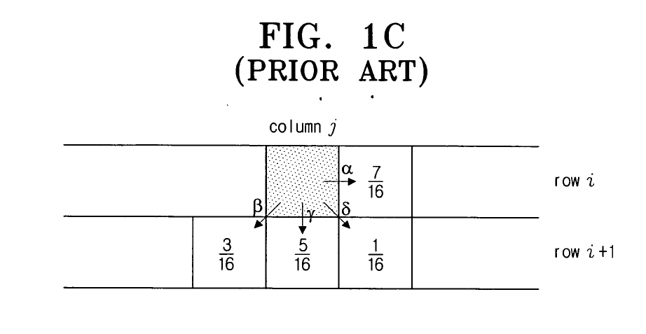

### DETAILED DESCRIPTION OF THE EXEMPLARY EMBODIMENTS

Hereinafter, certain exemplary embodiments of the present invention will be described in detail with reference to the accompanying drawing figures.

In the following description, the same drawing reference numerals are used for the same elements even in different drawings. Descriptions of certain items such as construction details and elements are merely provided to assist in a comprehensive understanding of the invention. Thus, it is apparent that the present invention can be carried out without the described details. Also, well-known functions or constructions are not described in detail since they would obscure the invention in unnecessary detail.

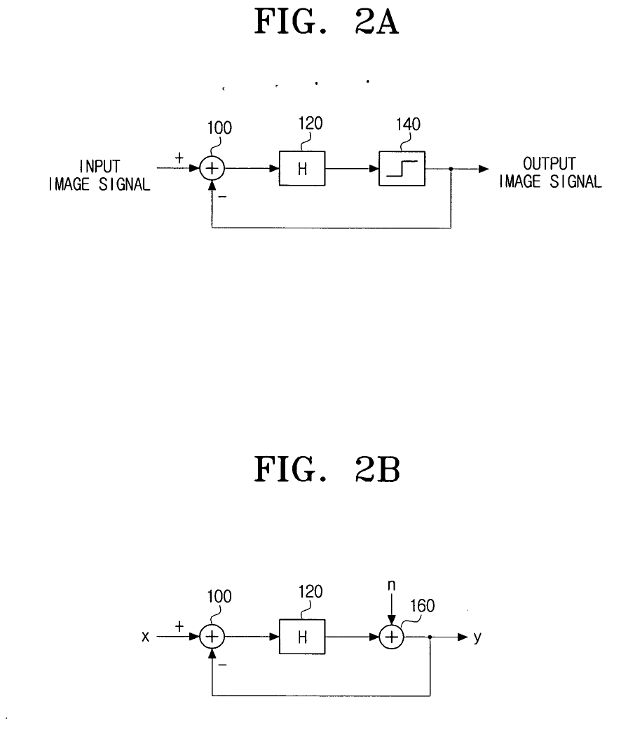

FIGS. 2A and 2B are views modeling a noise shaper applied to exemplary embodiments of the present invention.

FIG. 2A shows a first order noise shaper. Referring to FIG. 2A, the noise shaper according to this exemplary embodiment comprises a first adder 100, a filter 120, and a quantizer 140. As an input image signal being filtered by the filter 120 is quantized by the quantizer 140, an error is generated by the quantization. The quantizing error is fed back, subtracted from the input image signal through the first adder 100, filtered by the filter 120, and output.

The above processes are illustrated in FIG. 2B in which the quantizing error n is added to the input image signal x by a second adder 160. Referring to FIG. 2B, an operation of a noise shaper applied to the present invention will be described using Equation 3 as follows:
Y(z)=(X(z)−Y(z))H+N(z) (Equation 3)

In [Equation 3, Y(z) denotes the output image signal, X(z) denotes the input image signal, N(z) denotes the error caused by quantization, and H denotes the filter coefficient. The filter coefficient H may be expressed as

$$H = \frac{{z}^{- 1}}{1 - {z}^{- 1}} .$$

By applying the filter coefficient H to Equation 3, Equation 4 can be deduced as follows:
Y(z)=z⁻¹X(z)+(1−z⁻¹)Z(z) (Equation 4)

As shown in Equation 4, a function z⁻¹ denotes an all pass filter that passes all the input image signal. A function (1−z⁻¹) denotes a high pass filter that filters and outputs a low-frequency component, that is, the quantizing error.

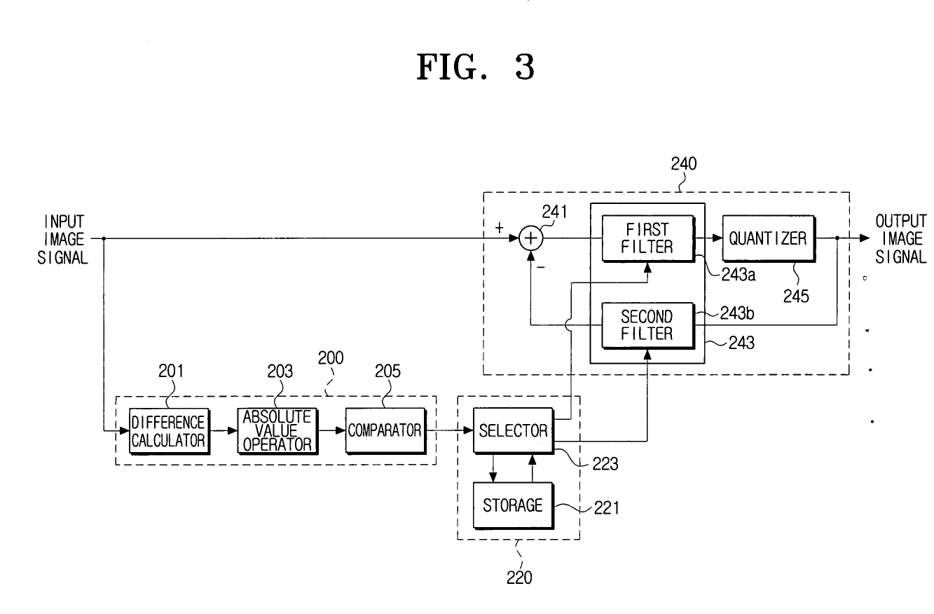

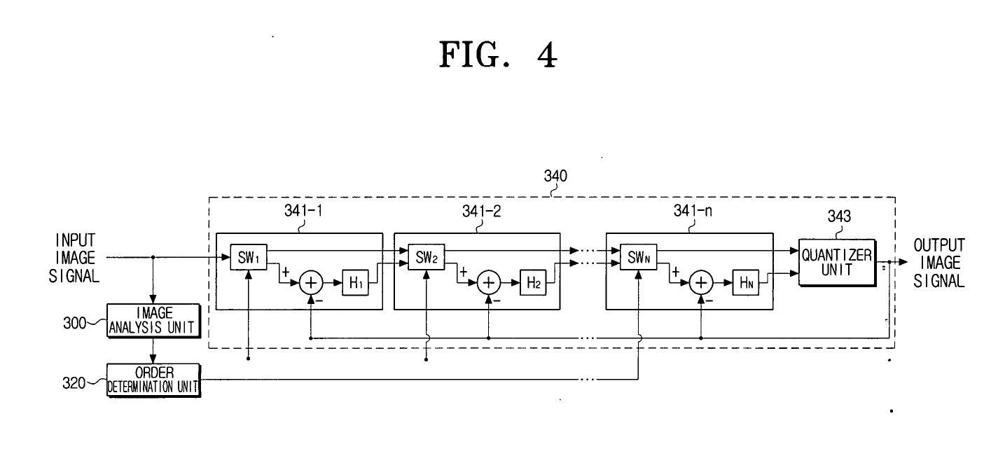

FIG. 3 shows a resolution conversion apparatus according to an exemplary embodiment of the present invention.

According to FIG. 3, the resolution conversion apparatus comprises an image analysis unit 200, a filter coefficient determination unit 220, and a noise shaper unit 240.

The image analysis unit 200 analyzes frequency characteristics of the input image signal, and comprises a difference value calculator 201, an absolute value operator 203, and a comparator 205.

The difference value calculator 201 calculates a difference value between pixel data neighboring the input image signal. More particularly, provided that first pixel data is P₁(i,j) and second pixel data is P₂(i,j+1), the difference between the first and the second pixel data is P₁(i,j)−P₂(i,j+1).

The absolute value operator 203 operates the difference value between the first and the second pixel data, calculated by the difference value calculator 201, and outputs an absolute value |P₁(i,j)−P₂(i,j+1)|. The comparator 205 compares the absolute value output from the absolute value operator 203 with a plurality of threshold values and outputs the result of comparison. For example, the comparator 205 may determine whether TH₁<|P₁(i,j)−P₂(i,j+1)|<TH₂, TH₂<|P₁(i,j)−P₂(i,j+1)|<TH₃, . . . .

The filter coefficient determination unit 220 determines the filter coefficient used for filtering the input image signal, and comprises a selector 223 and storage 221. Storage 221 stores the filter coefficient corresponding to threshold sections defined by the plurality of threshold values, in the form of a lookup table as shown by Table 1 below:

TABLE 1

| | |
|---|---|
| TH₁<a<TH₂ | coff_1 |
| TH₂<a<TH₃ | coff_2 |
| . . . | . . . |
| TH_{N-1}<a<TH_{N} | coff_n |

The selector 223 selects the filter coefficient stored in the storage 221 using the output from the comparator 205 and transmits the selected coefficient to the noise shaper unit 240. More specifically, when TH₁<|P₁(i,j)−P₂(i,j+1)|<TH₂, a filter coefficient coff_1 is selected. When TH₂<|P₁(i,j)−P₂(i,j+1)|<TH₃, a filter coefficient coff_2 is selected.

The noise shaper unit 240 performs noise shaping with respect to the quantizing error. To this end, the noise shaper unit 240 comprises an adder 241, a filter unit 243, and a quantizer unit 245.

The filter unit 243 comprises first and second filters 243a and 243b. The first filter 243a functions as a high pass filter (HPF) filtering low-frequency noise included in a signal output from the adder 241. The second filter 243b functions as a low pass filter (LPF) low-pass filtering a feedback signal.

The quantizer unit 245 quantizes the input image signal in which the low-frequency noise is filtered and outputs the quantized signal. Quantizing noise generated during this is passed through the second filter 243b as a feedback signal, subtracted from the input image signal through the adder 241, and then output.

Here, the first filter 243a and the second filter 243b function as an all pass filter (APF) that passes all the input image signal and the HPF that filters low-frequency noise, respectively.

As explained above, when the difference value between the neighboring pixels analyzed from the input image signal is great, a filter coefficient blocking the low-frequency noise is applied. When the difference value is small, a filter coefficient relieving blocking of the low-frequency noise is applied.

FIG. 4 is a view illustrating a resolution conversion apparatus according to another exemplary embodiment of the present invention.

Referring to FIG. 4, the resolution conversion apparatus comprises an image analysis unit 300, an order determination unit 320, and a noise shaper unit 340.

The image analysis unit 300 calculates a difference value between pixel data from the input image signal. More particularly, provided that first pixel data is P₁(i,j) and second pixel data neighboring the first pixel data is P₂(i,j+1), the difference between the first and the second pixel data is P₁(i,j)−P₂(i,j+1).

The order determination unit 320 determines an order for passing the input image signal through the noise shaper unit 340 according to the difference value between the pixel data calculated by the image analysis unit 300. The noise shaper unit 340 will be described hereinafter. Here, the order determination unit 320 determines the order logarithmically corresponding to the difference value between the neighboring pixel data.

The noise shaper unit 340 performs noise shaping with respect to errors generated by quantization of the input image signal, according to the determined order. The noise shaper unit 340 comprises first to N-th order units 341-1, 341-2, . . . , 341-n, and a quantizer unit 343. According to the order determined by the order determination unit 320, the first to N-th order units 341-1, 341-2, . . . , 341-n are switched on/off. The input image signal is filtered and output through filters H₁, H₂, . . . , H_{N} provided to the first to N-th order units 341-1, 341-2, . . . , 341-n of which switches SW₁, SW₂, . . . , SW_{N} are on.

The quantizer unit 343 quantizes the filtered input image signal. Quantizing errors generated during this are fed back.

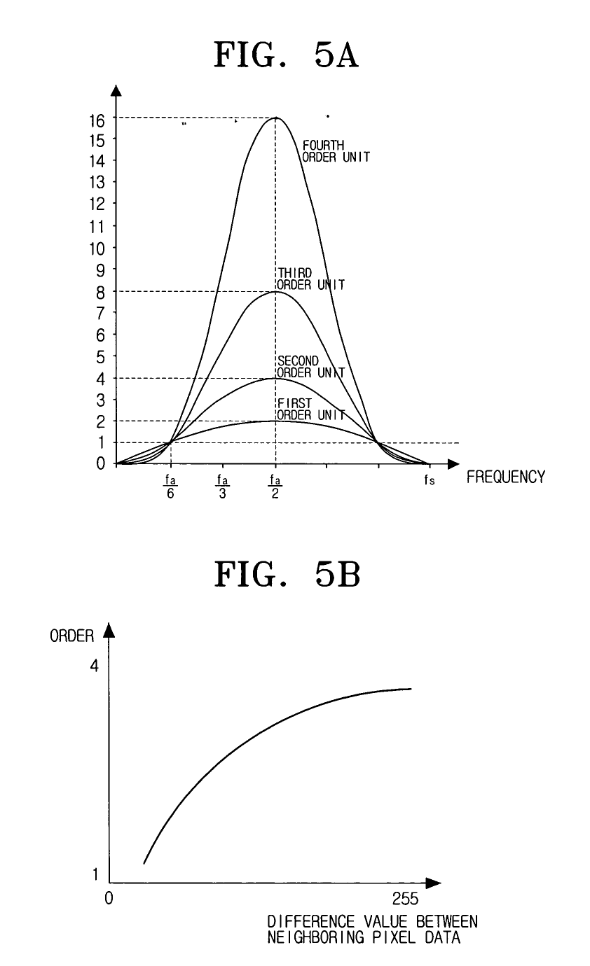

FIGS. 5A and 5B are views for explaining a method for determining the order of the resolution conversion apparatus of FIG. 4.

FIG. 5A shows frequency-response characteristics according to the order. Referring to FIG. 5A, the frequency-response characteristics of signals passed through both the first and the second order units 341-1 and 341-2 are better than those of signals passed through only the first order unit 341-1. The frequency-response characteristics of signals passed through the first to the third order units 341-1, 341-2, and 341-3 are better than those of signals passed through only the first and the second order units 341-1 and 341-2. In other words, as the signals pass through more order units 341-1, 341-2, . . . , 341-n, the frequency-response characteristics are improved. The order is logarithmically determined according to the difference value between the neighboring pixel data, as shown in FIG. 5B.

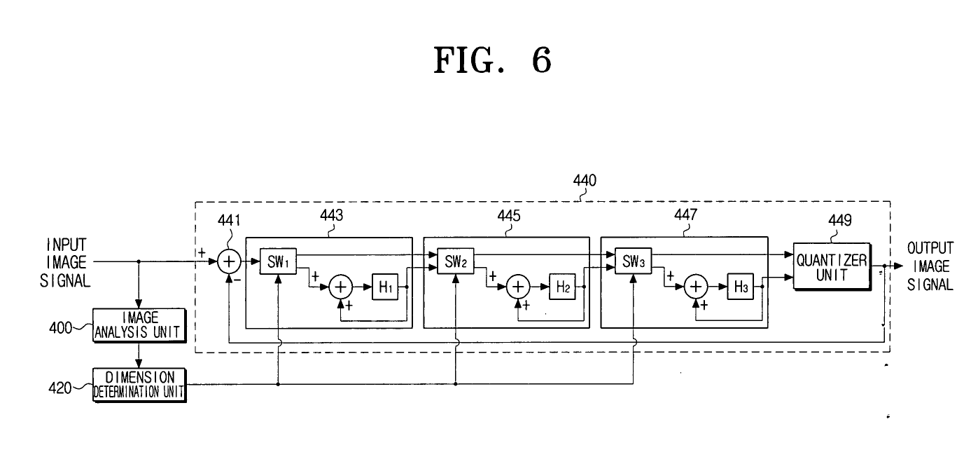

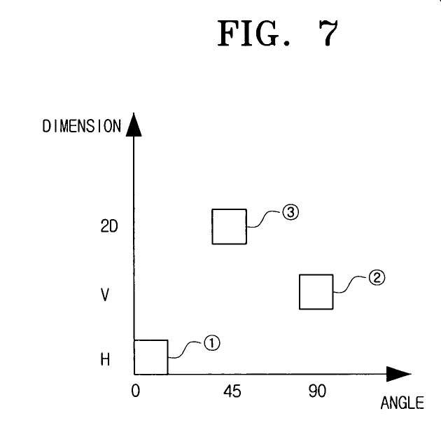

FIG. 6 shows a resolution conversion apparatus according to yet another exemplary embodiment of the present invention.

Referring to FIG. 6, the resolution conversion apparatus comprises an image analysis unit 400, a dimension determination unit 420, and a noise shaper unit 440.

The image analysis unit 400 analyzes edge direction from the input image signal. More specifically, whether edge direction is 0°, 90°, or 45° may be analyzed. The edge direction may be analyzed by more detailed angles.

The dimension determination unit 420 determines a dimension for performing noise shaping, according to the edge direction analyzed by the image analysis unit 400. For example, when the edge direction is 0°, noise shaping is horizontally performed and when 90°, vertically performed. When the edge direction is 45°, noise shaping is performed obliquely, that is, 2-dimensionally. When the edge direction is temporal, noise shaping may be performed with respect to a previous frame and a next frame, that is, 3-dimensionally.

The nose shaper unit 330 performs noise shaping with respect to the input image signal according to the determined dimension, and comprises an adder 441, a horizontal noise shaper unit 443, a vertical noise shaper unit 445, a temporal noise shaper unit 447, and a quantizer unit 449.

According to the dimension determined by the dimension determination unit 420, when the edge direction is 0°, the first switch SW₁ is turned on and noise shaping is performed horizontally by the horizontal noise shaper unit 443. When the edge direction is 90°, the second switch SW2 is turned on and noise shaping is performed vertically by the vertical noise shaper unit 445. In addition, when the edge direction is 45°, the first and the second switches SW₁ and SW₂ are turned on, and noise shaping is performed obliquely by the horizontal and the vertical noise shaper units 443 and 445. When the edge direction is temporal, the forth switch SW₄ is turned on so that noise shaping is performed temporally by the temporal noise shaper unit 447.

FIG. 7 is a view for explaining a method for determining dimension in the resolution conversion apparatus of FIG. 6.

As shown in FIG. 7, when the angle which is the edge direction is 0°, the dimension determination unit 420 performs noise shaping in a horizontal direction \textcircled{1} of 1-dimension, and when 90°, in a vertical direction \textcircled{2} of 1-dimension. When the angle is 45°, noise shaping is performed in an oblique direction \textcircled{3} of 2-dimension.

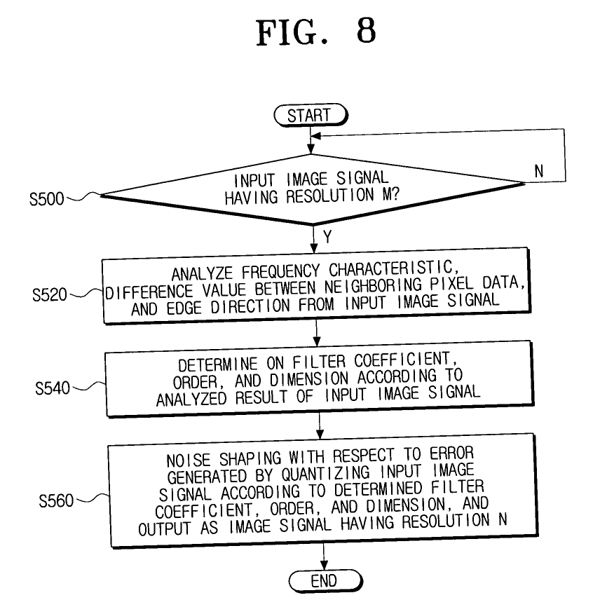

FIG. 8 is a view for explaining operations of the resolution conversion apparatus according to the above exemplary embodiments of the present invention.

Referring to FIG. 8, when image signal having resolution M is input (S500), the resolution conversion apparatus according to exemplary embodiments of the present invention analyzes the frequency characteristics, the difference value between the neighboring pixel data, and the edge direction (S520).

Then, the resolution conversion apparatus determines the filter coefficient, the order, and the dimension according to the analyzed result of the input image signal. More specifically, the frequency characteristics of the input image signal are analyzed, thereby determining the filter coefficient. The order of the noise shaper unit 340 is determined using the difference value between the neighboring pixel data. Also, the dimension for performing noise shaping is determined by analyzing the edge direction (S540).

Noise shaping is performed with respect to the errors generated by quantization of the input image signal, according to the determined filter coefficient, the order, and the dimension. As a result, an image signal having the resolution N is output (S560).

According to the above processes, noise shaping may be performed with the quantizing errors generated according to the characteristics of the input image signal.

As can be appreciated from the above description, an adaptive resolution conversion apparatus and a method for the same, capable of preventing deterioration of image quality when reducing the resolution since noise shaping is performed according to characteristics of the input image signal, thereby minimizing the quantizing errors, can be realized.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A resolution conversion apparatus, comprising:
an image analysis unit analyzing frequency characteristics of an input image signal;
a filter coefficient determination unit setting a filter coefficient according to the frequency characteristics; and
a noise shaper unit performing noise shaping with respect to an error generated by quantizing the input image signal, according to the filter coefficient.

2. The resolution conversion apparatus of claim 1, wherein the noise shaper unit comprises a filter unit performing noise shaping using a following equation:
$$Y = ( X - Y ) \frac{{z}^{- 1}}{1 - {z}^{- 1}} + N .$$
wherein, Y denotes an output image signal, X denotes an input image signal, Z⁻¹ denotes an all pass filter, 1−Z⁻¹ denotes a high pass filter, and N denotes a quantizing error.

3. The resolution conversion apparatus of claim 1, wherein the image analysis unit comprises:
a difference value calculator calculating a difference value between pixel data neighboring the input image signal;
an absolute value operator calculating an absolute value of the difference value; and
a comparator comparing the absolute value with a plurality of threshold values.

4. The resolution conversion apparatus of claim 3, further comprising:
a storage storing the filter coefficient corresponding to threshold sections defined by the plurality of threshold values, in the form of a lookup table; and
a selector selecting the filter coefficient from the storage, according to a result of comparison between the absolute value and the threshold values.

5. A resolution conversion apparatus comprising:
an image analysis unit calculating a difference value between pixel data neighboring an input image signal;
an order determination unit determining an order for passing the input image signal according to the difference value calculated by the image analysis unit; and
a noise shaper unit performing noise shaping with respect to an error generated by quantizing the input image signal, according to the order determined by the order determination unit.

6. The resolution conversion apparatus of claim 5, wherein the noise shaper unit comprises a plurality of switches for selecting one of bypassing and noise shaping of the input image signal, according to the order.

7. The resolution conversion apparatus of claim 5, wherein the order determination unit determines the order logarithmically corresponding to the difference value.

8. A resolution conversion apparatus comprising:
an image analysis unit analyzing an edge direction from an input image signal;
a dimension determination unit determining dimension for performing noise shaping with respect to an error generated by quantizing the input image signal, according to the edge direction; and
a noise shaper unit performing noise shaping according to the dimension.

9. The resolution conversion apparatus of claim 8, wherein the noise shaper unit comprises:
a horizontal noise shaper performing noise shaping in a horizontal direction when the edge direction is 0°; and
a vertical noise shaper performing noise shaping in a vertical direction when the edge direction is 90°.

10. The resolution conversion apparatus of claim 9, wherein when the edge direction is 45°, the dimension determination unit turns on switches of the horizontal and the vertical noise shaping units to perform noise shaping in an oblique direction of 2-dimensions.

11. The resolution conversion apparatus of claim 9, wherein the noise shaper unit further comprises a temporal noise shaper unit performing noise shaping in a temporal direction.

12. A method for converting resolution, comprising:
analyzing at least one characteristic among frequency characteristics of an input image signal, a difference value between neighboring pixel data, and an edge direction; and
performing noise shaping with respect to a quantizing error according to at least one of the characteristics.

13. The method of claim 12, wherein the operation of performing noise shaping comprises:
selecting a filter coefficient according to the frequency characteristic; and
performing noise shaping with respect to the quantizing error by applying a filter coefficient.

14. The method of claim 12, wherein the operation of performing noise shaping comprises:
determining an order of noise shaping the input image signal, according to the difference value between the neighboring pixel data; and
performing one of bypassing and noise shaping of the input image signal according to the order.

15. The method of claim 12, wherein the operation of performing noise shaping comprises:
determining a dimension for performing noise shaping with respect to an error generated by quantizing the input image signal, according to the edge direction; and
performing noise shaping according to the dimension.
